(19) United States
(12) Patent Application Publication
(10) Pub. No.: US 2020/0095769 A1
(43) Pub. Date: Mar. 26, 2020

(54) ROOFING UNDERLAYMENT AND PREPARATION METHOD THEREOF

(71) Applicant: CHANGZHOU PROFIT BUILDING TECHNOLOGY CO., LTD., Changzhou City (CN)

(72) Inventors: XIAO-MING XU, CHANGZHOU CITY (CN); LIANG GAO, CHANGZHOU CITY (CN)

(21) Appl. No.: 16/137,708

(22) Filed: Sep. 21, 2018

(51) Int. Cl. E04D 12/00; B32B 5/02; B32B 11/10; B32B 11/04; B32B 7/12; B32B 27/12; B32B 37/15

(52) U.S. Cl. CPC E04D 12/002; B32B 5/022; B32B 11/10; B32B 11/046; B32B 7/12; B32B 2307/718; B32B 37/15; B32B 2255/26; B32B 2255/02; B32B 2419/06; B32B 27/12

(57) ABSTRACT

A roofing mat and a preparation method thereof are disclosed. A composite device includes a first roller, a second roller and a third roller. A die is located at the first roller. The preparation method comprises the following steps: step 1: laminating a first non-woven fabric to form a waterproof film; step 2: conveying asphalt to the die; step 3: rolling the first non-woven fabric by means of the first roller, rolling a woven fabric/a second non-woven fabric by means of the second roller, applying the asphalt to the waterproof film of the first non-woven fabric by means of the die, the first roller and the second roller being rolled and pressed against each other, the first non-woven fabric rolled by the first roller and the woven fabric/the second non-woven fabric rolled by the second roller being compressed together and then conveyed to a third roller for cooling, outputting, trimming, and winding.

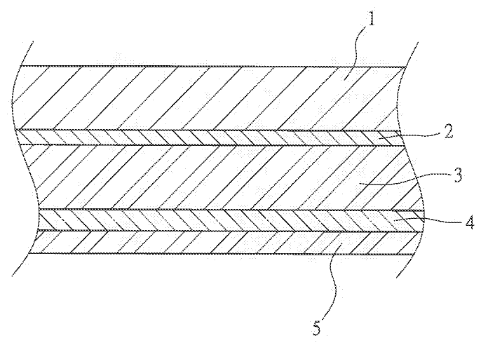

### FIELD OF THE INVENTION

The present invention relates to the field of building material engineering, and more particularly to a roofing underlayment and a preparation method thereof.

### BACKGROUND OF THE INVENTION

A roofing underlayment is a waterproof material widely used for roofing. The roofing underlayment is mainly used for waterproofing of slope roofs. It is the first barrier for roof waterproofing and is in direct contact with roofing. It plays a vital role for waterproofing of tile roofs, metal roofs or other roofs.

However, most of the roofing waterproofing underlayment on the market is made of woven or non-woven fabrics by lamination. The roofing underlayment is directly fixed to a roof with a lot of nails. In this way, the position of the nail hole is prone to leakage, which makes the waterproofing of the house fail and results in water seepage or water leakage. This is a problem that exists in most of the roofing underlayment on the market and cannot be solved. Although some products claim to solve the problem of the leakage caused by nail holes through different technologies, the bottom surface of such a product is in direct contact with the roof, and the underlayment easily slips off from the roof.

Accordingly, the inventor of the present invention has devoted himself based on his many years of practical experiences to solve these problems.

### SUMMARY OF THE INVENTION

The primary object of the present invention is to provide a roofing underlayment and a preparation method thereof, having good waterproof performance for sealing nail holes.

A further object of the present invention is to provide a roofing underlayment and a preparation method thereof, having good anti-slip performance and good safety.

According one aspect of the present invention, a roofing underlayment is provided. The roofing underlayment comprises a four-layer structure having a first non-woven fabric, a waterproof film, an asphalt layer and a woven fabric/a second non-woven fabric arranged in order from top to bottom. The waterproof film is applied to an inner side of the first non-woven fabric. The asphalt layer is applied between the waterproof film and an inner side of the woven fabric/an inner side of the second non-woven fabric.

Preferably, the first non-woven fabric and the second non-woven fabric is made of a non-woven fabric having a weight of between 10 g and 100 g per square meter, and the non-woven fabric is a spunbonded, meltblown, needled or spunlace non-woven fabric.

Preferably, the waterproof film is a polyolefin-based extruded casting film or an elastomer-based extruded casting film or a hot-rolled composite film or an adhesive composite film.

Preferably, the asphalt layer includes 30-70 wt % asphalt, 1-15 wt % SBS, 20-60 wt % filler, and 0.1-2 wt % tackifier. The asphalt layer has a thickness of not greater than 10 mils.

Preferably, the woven fabric is made of a circular-knitting, plain-knitting, spunlace or warp-knitting woven fabric having a weight of between 20 g and 300 g per square meter, and its material is polypropylene (PP) or polyethylene (PE) or polyethylene terephthalate (PET) or polyamide nylon.

Preferably, an anti-slip film is applied to an outer side of the woven fabric/the second non-woven fabric.

Preferably, the anti-slip film is a polyolefin-based extruded casting anti-slip film or an elastomer-based extruded casting anti-slip film or a rolled coating anti-slip film.

According another aspect of the present invention, a preparation method of a roofing underlayment is provided. A composite device is used for preparation. The composite device includes a first roller, a second roller and a third roller arranged from left to right. A die is located at a left side of the first roller. The preparation method comprises the following steps:

step 1: laminating an inner side of a first non-woven fabric to form a waterproof film on the inner side;

step 2: conveying asphalt to the die;

step 3: rolling the first non-woven fabric having the waterproof film by means of the first roller, rolling a woven fabric/a second non-woven fabric by means of the second roller, applying the asphalt to the inner side having the waterproof film of the first non-woven fabric by means of the die, the first roller and the second roller being rolled and pressed against each other, the inner side having the waterproof film of the first non-woven fabric rolled by the first roller and an inner side of the woven fabric/the second non-woven fabric rolled by the second roller being compressed together and then conveyed to a third roller for cooling, outputting, trimming, and winding.

Preferably, a heating medium is provided in the first roller and the second roller. A cooling medium is provided in the third roller.

Preferably, the preparation method, in the step 1, further comprises performing an anti-slip coating treatment on an outer side of the woven fabric/the second non-woven fabric to form an anti-slip film on the outer side.

After adopting the above scheme, a thin layer of viscous asphalt is formed in the middle of the underlayment through the independent asphalt coating technology, so that the underlayment forms a good self-closing seal around the nail hole in the process of fixing the nail. The present invention solves the problem of the water leakage caused by the nail hole of the conventional roofing underlayment. The anti-slip film is arranged at the bottom of the underlayment, thereby avoiding the sliding of the underlayment relative to the contact surface of the roof during the construction process and increasing the construction safety.

According to the above technical features, the following effects can be achieved:

1. The present invention provides an asphalt layer in the middle of the product, which effectively prevents water leakage caused by nails. Besides, the asphalt layer is thin, which reduces the cost, reduces the weight of the product, and facilitates the handling.

2. The present invention provides a non-slip film on the outer side of the woven fabric or the second non-woven fabric, that is, the bottom of the product, so that the contact between the product and the roof is more firm, avoiding relative sliding and making the construction safer.

### BRIEF DESCRIPTION OF THE DRAWINGS

The FIGURE is a structural schematic view of a roofing underlayment in accordance with the present invention.

### DETAILED DESCRIPTION OF THE PREFERRED EMBODIMENTS

Embodiments of the present invention will now be described, by way of example only, with reference to the accompanying drawings.

### First Embodiment

As shown in the FIGURE, a roofing underlayment in accordance with a preferred embodiment of the present invention comprises a five-layer structure having a non-woven fabric 1, a waterproof film 2, an asphalt layer 3, a woven fabric 4, and an anti-slip film 5 arranged in order from top to bottom.

The non-woven fabric 1 is made of a non-woven fabric having a weight of between 10 g and 100 g per square meter. The non-woven fabric may be a spunbonded, meltblown, needled or spunlace non-woven fabric made of polypropylene (PP), polyester (polyethylene terephthalate, PET), nylon PA or other composite materials.

The waterproof film 2 is applied to the contact surfaces between the non-woven fabric 1 and the asphalt layer 3. Specifically, the waterproof film 2 may be a polyolefin-based extruded casting film or an elastomer-based extruded casting film or a hot-rolled composite film or an adhesive composite film.

The asphalt layer 3 is uniformly applied between the waterproof film 2 and the woven fabric 4. The asphalt layer includes 30-70 wt % asphalt, 1-15 wt % SBS, 20-60 wt % filler, and 0.1-2 wt % tackifier. The asphalt layer has a thickness of not greater than 10 mils (0.25 mm). In this embodiment, the thickness is 1 mil.

The woven fabric 4 is made of a circular-knitting, plain-knitting, spunlace or warp-knitting woven fabric having a weight of between 20 g and 300 g per square meter, and its material may be polypropylene (PP) or polyethylene (PE) or polyethylene terephthalate (PET) or polyamide nylon.

The anti-slip film 5 is applied to the outer side of the woven fabric 4. The anti-slip film 5 is a polyolefin-based extruded casting anti-slip film or an elastomer-based extruded casting anti-slip film or a rolled coating anti-slip film.

The present invention also provides a preparation method of a roofing underlayment by using a composite device including a first roller, a second roller, and a third roller arranged from left to right. A die is located at the left side of the first roller. A heating medium is provided in the first roller and the second roller. A cooling medium is provided in the third roller to ensure that the finished product is flat and perfect. The preparation method comprises the following steps:

step 1: laminating one side of a non-woven fabric to form a waterproof film on the side; and performing an anti-slip coating treatment on one side of a woven fabric to form an anti-slip film on the side of the woven fabric;

step 2: measuring, heating, stirring asphalt in a tank, and conveying the stirred asphalt to the die with a high pressure pump;

Step 3: rolling the non-woven fabric having the waterproof film by means of the first roller, rolling the woven fabric having the anti-slip film by means of the second roller, uniformly applying the asphalt on the side having waterproof film of the non-woven fabric by means of the die, the first roller and the second roller being rolled and pressed against each other, the laminating surface (that is, the waterproof film) of the non-woven fabric rolled by the first roller and a woven fabric surface (that is, another side of the anti-slip film) of the woven fabric rolled by the second roller being compressed together and then conveyed to a third roller for cooling, outputting, trimming, and winding.

### Second Embodiment

The difference between the second embodiment and the first embodiment is the fourth layer from top to bottom. The woven fabric 4 is replaced with the same structure as the first layer. The non-woven fabric is made of a non-woven fabric having a weight of between 10 g and 100 g per square meter. The non-woven fabric may be a spunbonded, meltblown, needled or spunlace nonwoven made of polypropylene (PP), polyester (polyethylene terephthalate, PET), nylon PA or other composite materials.

### Third Embodiment

The difference between the third embodiment and the second embodiment is that the fifth layer from top to bottom, namely, the anti-slip film 5, is not provided.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A roofing underlayment, comprising a four-layer structure having a first non-woven fabric, a waterproof film, an asphalt layer and a woven fabric/a second non-woven fabric arranged in order from top to bottom, wherein the waterproof film is applied to an inner side of the first non-woven fabric, the asphalt layer is applied between the waterproof film and an inner side of the woven fabric/an inner side of the second non-woven fabric.

2. The roofing underlayment as claimed in claim 1, wherein the first non-woven fabric and the second non-woven fabric is made of a non-woven fabric having a weight of between 10 g and 100 g per square meter, and the non-woven fabric is a spunbonded, meltblown, needled or spunlace non-woven fabric.

3. The roofing underlayment as claimed in claim 2, wherein the waterproof film is a polyolefin-based extruded casting film or an elastomer-based extruded casting film or a hot-rolled composite film or an adhesive composite film.

4. The roofing underlayment as claimed in claim 1, wherein the asphalt layer includes 30-70 wt % asphalt, 1-15 wt % SBS, 20-60 wt % filler and 0.1-2 wt % tackifier, and the asphalt layer has a thickness of not greater than 10 mils.

5. The roofing underlayment as claimed in claim 1, wherein the woven fabric is made of a circular-knitting, plain-knitting, spunlace or warp-knitting woven fabric having a weight of between 20 g and 300 g per square meter, and its material is polypropylene (PP) or polyethylene (PE) or polyethylene terephthalate (PET) or polyamide nylon.

6. The roofing underlayment as claimed in claim 1, wherein an anti-slip film is applied to an outer side of the woven fabric/the second non-woven fabric.

7. The roofing underlayment as claimed in claim 6, wherein the anti-slip film is a polyolefin-based extruded casting anti-slip film or an elastomer-based extruded casting anti-slip film or a rolled coating anti-slip film.

8. A preparation method of a roofing underlayment, using a composite device for preparation, the composite device including a first roller, a second roller and a third roller arranged from left to right, a die being located at a left side of the first roller; the preparation method comprising the following steps:
step 1: laminating an inner side of a first non-woven fabric to form a waterproof film on the inner side;
step 2: conveying asphalt to the die;
step 3: rolling the first non-woven fabric having the waterproof film by means of the first roller, rolling a woven fabric/a second non-woven fabric by means of the second roller, applying the asphalt to the inner side having the waterproof film of the first non-woven fabric by means of the die, the first roller and the second roller being rolled and pressed against each other, the inner side having the waterproof film of the first non-woven fabric rolled by the first roller and an inner side of the woven fabric/the second non-woven fabric rolled by the second roller being compressed together and then conveyed to a third roller for cooling, outputting, trimming, and winding.

9. The preparation method as claimed in claim 8, wherein a heating medium is provided in the first roller and the second roller, and a cooling medium is provided in the third roller.

10. The preparation method as claimed in claim 8, in the step 1, further comprising performing an anti-slip coating treatment on an outer side of the woven fabric/the second non-woven fabric to form an anti-slip film on the outer side.
